(19) United States
(12) Patent Application Publication
(10) Pub. No.: US 2019/0107141 A1
(43) Pub. Date: Apr. 11, 2019

(54) LOCK BOLT ASSEMBLY

(71) Applicant: KYLIN SANITARY TECHNOLOGY (XIAMEN) CO., LTD., Xiamen City (CN)

(72) Inventors: You Huan FANG, XIAMEN CITY (CN); Jin Shou CHEN, XIAMEN CITY (CN); Qing Shuang LI, XIAMEN CITY (CN)

(21) Appl. No.: 15/851,124

(22) Filed: Dec. 21, 2017

(30) Foreign Application Priority Data
Oct. 9, 2017 (CN) 201721291984.9

(51) Int. Cl. F16B 39/282

(52) U.S. Cl. CPC F16B 39/282

(57) ABSTRACT

The invention discloses a lock bolt assembly comprising a bolt provided with a first external thread, a mounting nut correspondingly screwed on the bolt and provided with a first internal thread, and a locking piece, wherein in the length direction of the bolt, at least one cantilever part is formed on the mounting nut in an extension mode, and the first internal thread extends onto the cantilever parts; the locking piece is arranged on the mounting nut and can abut against the cantilever parts, so that the areas, where the first internal thread is formed, of the cantilever parts bend and tightly press the first external thread in an abutting mode, then different areas of the first internal thread on the mounting nut abut against and tightly press the first external thread in two opposite directions, and thus the bolt is prevented from rotating relative to the mounting nut.

### BACKGROUND OF THE INVENTION

### Technical Field

The invention belongs to the technical field of threaded fasteners for mechanical connection, and particularly relates to a lock bolt assembly resistant to impact vibration.

### Description of Related Art

Fasteners are indispensable when various machines and components are connected and assembled. Fasteners and particularly threaded fasteners bring convenience for the mechanical industry, however, the fasteners have an inevitable disadvantage in that the fasteners can become loose during violent or frequent vibration, and consequentially a component or a complete device is damaged and disassembled, and even accidents are caused.

An external thread of an existing common bolt is generally formed by arranging a complete 60-degree cone along a spiral line, and during assembling, the bolt is used in pair and cooperation with a nut provided with a conventional thread. The size of the thread pitch of the internal thread of the nut is the same as that of the thread pitch of the external thread of the bolt 1, in the screwing process, with the screwing-in direction of the nut as the forward direction, the thread teeth of the internal thread of the nut are correspondingly screwed into the thread grooves of the external thread of the bolt, the 60-degree oblique planes on the rear sides of the thread teeth are correspondingly attached to the 60-degree oblique planes on the front sides of the thread grooves.

According to an existing static anti-loosening principle: the direction of the clamping force provided by the nut for a workpiece is the same as the screwing direction of the nut, in the assembling process, the rear oblique plane, backing onto the direction of the clamping force, of the two side oblique planes of each thread groove of the external thread makes contact with the rear oblique plane, backing onto the direction of the clamping force under the reversed effect of the clamping force, of the two side oblique planes of each thread tooth of the internal thread, and meanwhile, the lowest anti-loosening requirement is met through friction between the two rear oblique planes.

According to an existing vibrating anti-loosening principle: under the reversed effect of the clamping force, the font oblique plane of the two side oblique planes of the external thread of the bolt is in clearance fit with the front oblique plane of the two side oblique planes of the internal thread of the nut, and the self-locking anti-loosening performance of a lock bolt assembly is reduced through the clearance.

A self-locking bolt is disclosed by the Chinese invention patent with the authorization notification NO. CN201582278U, the self-locking bolt comprises a bolt body and an external thread arranged on the bolt body, and the bottom surfaces of the thread grooves of the external thread are wedge-shaped oblique planes. When a nut and the bolt are screwed together in use, the tooth points of the thread teeth of the internal thread abut against the wedge-shaped oblique planes of the thread grooves, so that normal force which is much larger than that of a standard thread is generated, the frictional force between the internal thread and the external thread can be increased greatly through the normal force, and thus the purposes of looseness-preventing and self-locking are achieved. However, clearances between the front oblique plane of the two side oblique planes of each thread groove of the external thread of the bolt and the front oblique plane of the two side oblique planes of each thread tooth of the internal thread of the nut still cannot be eliminated by increasing the normal force through the wedge-shaped oblique planes in the assembling process, and the influence of the wedge-shaped oblique planes on the self-locking and looseness-preventing performance of the bolt assembly is lowered.

### BRIEF SUMMARY OF THE INVENTION

The invention aims to provide a lock bolt assembly to solve the problem that an existing bolt assembly is poor in vibration fastening performance and prone to becoming loose.

According to the specific scheme: a lock bolt assembly comprises a bolt provided with a first external thread and a mounting nut correspondingly screwed on the bolt and provided with a first internal thread, wherein in the length direction of the bolt, at least one cantilever part is formed on the mounting nut in an extension mode, and the first internal thread extends onto the cantilever parts; the lock bolt assembly further comprises a locking piece, the locking piece is arranged on the mounting nut and can abut against the cantilever parts, so that the areas, where the first internal thread is formed, of the cantilever parts bend and tightly press the first external thread in an abutting mode, then different areas of the first internal thread on the mounting nut abut against and tightly press the first external thread in two opposite directions, and thus the bolt is prevented from rotating relative to the mounting nut.

Furthermore, a second external thread is arranged on the outer peripheral wall of the mounting nut, the locking piece is a lock nut provided with a second internal thread, and the lock nut is screwed on the mounting nut through cooperation between the second internal thread and the second external thread.

Furthermore, the number of the number of the cantilever parts is two, the two cantilever parts are arranged on the two opposite sides of the bolt in the width direction respectively, and a deformation gap is formed between the two cantilever parts; the second external thread is arranged on the cantilever parts so that the lock nut can be arranged on the two cantilever parts in a sleeving mode, and the two cantilever parts are tightly pressed on the first external thread in an abutting mode.

Furthermore, the cross section of each cantilever part is in an arc shape, so that the first internal thread and the second external thread are formed on the inner side face and the outer side face of the cantilever part respectively.

Furthermore, according to the technical scheme of the invention, in the screwing direction of the lock nut, a plurality of clamping grooves are further formed in the front end face of the lock nut, and correspondingly, clamping buckles are further arranged on the mounting nut in a protruding mode towards the front end face of the lock nut; the lock nut is screwed on the mounting nut, then the clamping buckles are clamped in the clamping grooves, and thus the lock nut is fixed.

Furthermore, the number of the clamping grooves is more than one, the multiple clamping grooves are evenly distributed in the circumferential direction with the bolt as the axis; the number of the clamping buckles is two, and the two clamping buckles are mounted on the two opposite sides of the mounting nut in the width direction respectively.

According to the technical scheme of the utility mode, defining the screwing-in direction of the mounting nut as the forward direction, first, the main body part of the mounting nut abuts against the first external thread through the oblique plane on the rear side of each thread tooth of the first internal thread, so that a mounted part is fixed, and the front end of the mounted part is prevented from getting loose; second, due to swinging deformation of the cantilever parts, the oblique plane on the front side of each thread tooth of the first internal thread on the cantilever parts abuts against the oblique plane on the rear side of each thread tooth of the first external thread, accordingly, different areas of the first internal thread on the mounting nut abut against and tightly press the first external thread in two opposite directions, the fit clearance which can cause vibration and looseness is zero, and the technical effect of preventing looseness and vibration is achieved.

In addition, according to the technical scheme of the invention, both the thread structure of the mounting nut and the thread structure of a screw are common thread structures in the prior art and do not need to be redesigned, and the machining technique and machining equipment are general, so that the lock bolt assembly is low in transformation cost and wide in application range.

### BRIEF DESCRIPTION OF THE SEVERAL VIEWS OF THE DRAWINGS

FIG. 1 shows a structural diagram of an embodiment of the invention;

FIG. 2 shows an exploded view of FIG. 1;

FIG. 3 shows a sectional view of FIG. 1;

FIG. 4 shows a lateral view of a mounting nut in FIG. 2.

### DETAILED DESCRIPTION OF THE INVENTION

For a further description of all embodiments, the drawings are provided by the invention. The drawings are part of the content disclosed by the invention and are mainly used for illustrating the embodiments and explaining the operation principle of the embodiments in cooperation with relevant content in the description. By referring to the content, those skilled in the field can understand other possible execution modes and advantages of the invention. Components in the drawings are not drawn in proportion, and similar component symbols are generally used for representing similar components.

A further description of the invention is given with accompanying drawings and the specific embodiment.

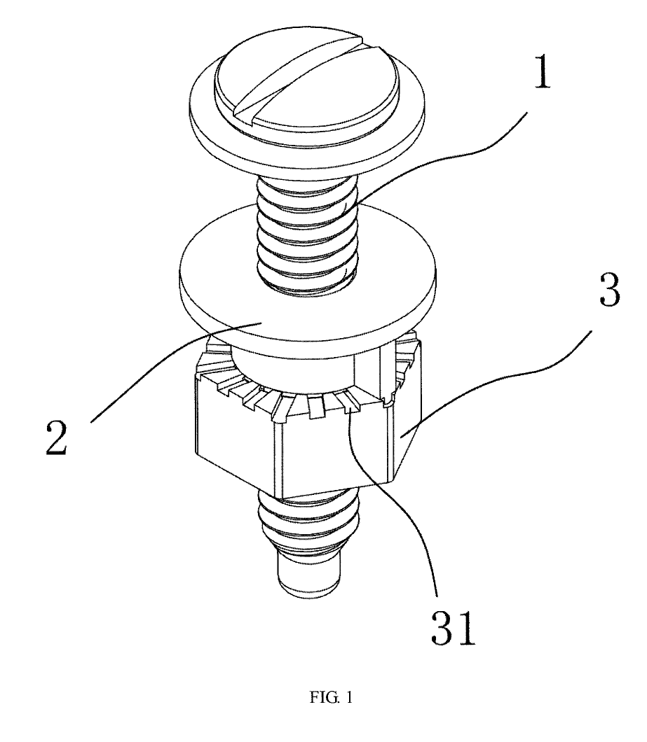

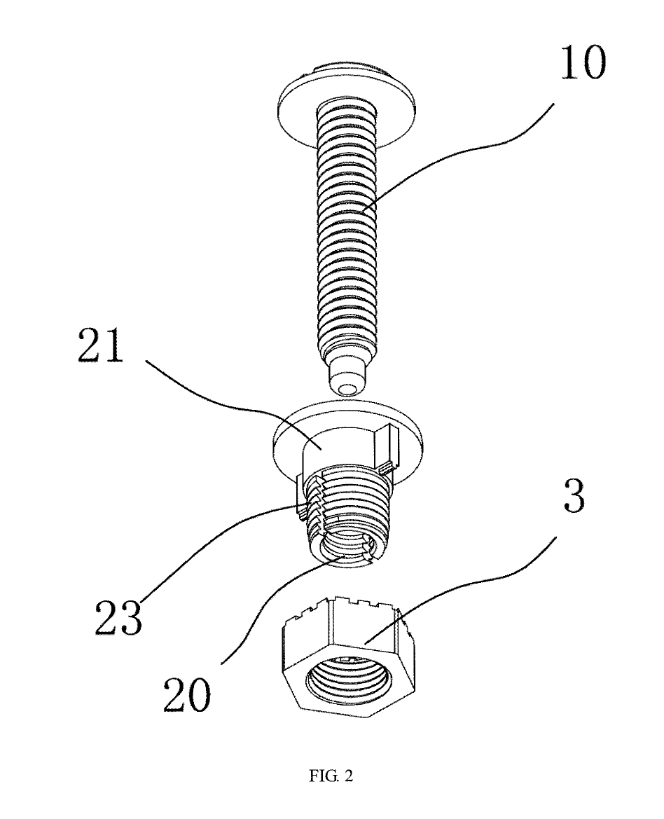

As is shown in FIG. 1 and FIG. 2, the embodiment of the invention provides a lock bolt assembly comprising a bolt 1, a mounting nut 2 and a lock nut 3, wherein the mounting nut 2 is mounted on the bolt 1 in a threaded mode, and the lock nut 3 is mounted on the mounting nut 2 in a threaded mode.

Specifically, the bolt 1 is provided with a first external thread 10, correspondingly, the mounting nut 2 is provided with a first internal thread 20 matched with the first external thread 10, and then the mounting nut 2 is screwed on the bolt 1; similarly, a second external thread is arranged on the outer peripheral wall of the mounting nut 2, the lock nut 3 serving as a locking piece is provided with a second internal thread matched with the second external thread, and the lock nut 3 is screwed on the mounting nut 2 through cooperation between the second internal thread and the second external thread; in the embodiment, the mounting nut 2 and the lock nut 3 are screwed in the same direction.

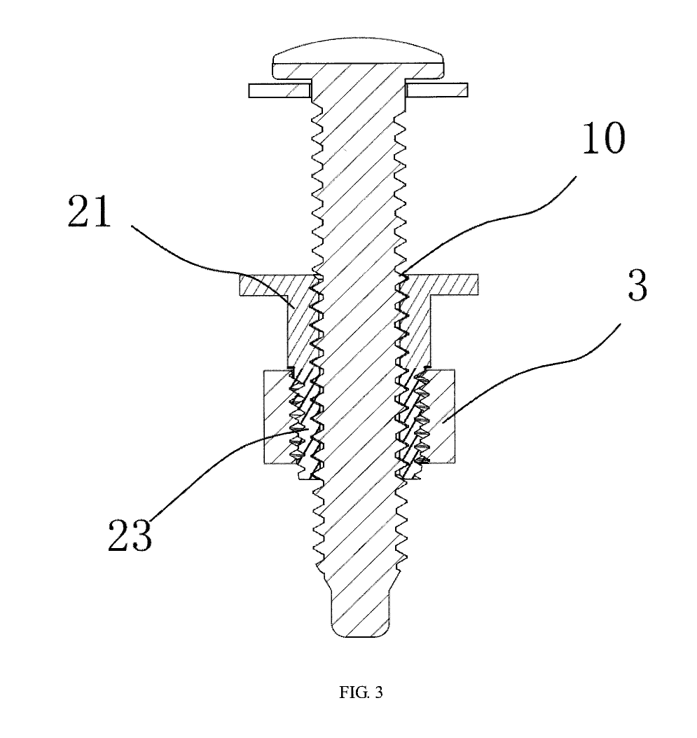

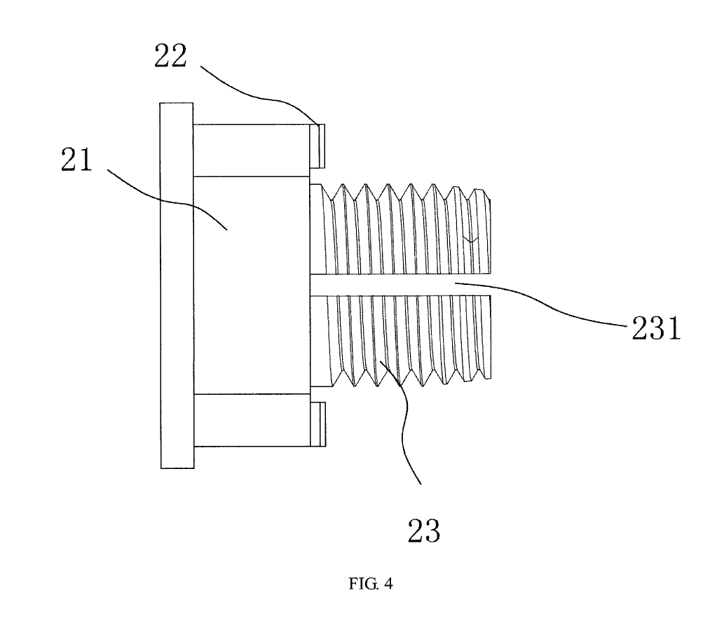

As is shown in FIG. 3 and FIG. 4, the direction in which the mounting nut 2 is screwed in the bolt 1 is defined as the forward direction, and in FIG. 3, the upward direction of FIG. 3 is the forward direction in the embodiment. The mounting nut 2 is provided with a main body part 21, at least two cantilever parts 23 are formed at the rear end of the main body part 21 in the length direction of the bolt 1 through backward extension, the two cantilever parts 23 are arranged on the two opposite sides of the bolt 1 in the width direction correspondingly, and a deformation gap 231 is formed between the two cantilever parts 23 and used for allowing the cantilever parts 23 to swing relative to the main body part 21.

The front end of the first internal thread is formed on the main body part 21, and the first internal thread 20 extends onto the inner side walls of the cantilever parts 23; correspondingly, the second external thread is formed on the outer side walls of the cantilever parts 23, the cross section of each cantilever part 23 is in an arc shape, and the inner side and the outer side of each cantilever part 23 are used for being matched with the bolt 1 and the lock nut 3 respectively.

The lock nut 3 is rotatably mounted through the second internal thread and arranged on the two cantilever parts 23 in a sleeving mode; in the embodiment, the diameter of the second internal thread is smaller than that of the second external thread so that the lock nut 3 can tightly press the two cantilever parts 23, the cantilever parts 23 deform and deflect from the fixed ends, and the first internal thread 20 on the cantilever parts 23 abut against and tightly press the first external thread 10.

Under the effect of the pressure of the mounted part, the rear side faces of the thread teeth of the first internal thread 20 on the main body part 21 abut against the front side faces of thread teeth of the first external thread 10; since the cantilever parts 23 deform and deflect, the first internal thread 20 formed on the cantilever parts 23 abuts against and tightly presses the first external thread 10, the front side faces of the thread teeth of the first internal thread 20 in the areas abut against the rear side faces of the thread teeth of the first external thread 20, and the clearance which can cause vibration and looseness is eliminated, so that the thread teeth in different areas at the front end and the rear end of the first internal thread 20 on the mounting nut 2 abut against and tightly press the thread teeth of the first external thread 10 in two opposite directions, and thus the bolt 1 is prevented from rotating relative to the mounting nut 2.

As is shown in FIG. 1 and FIG. 4, for firmly connecting the mounting nut 2 and the lock nut 3, a plurality of clamping grooves 31 are further formed in the front end face of the lock nut 3 in the screwing direction of the lock nut 3, preferably, the number of the clamping grooves 31 is more than one, the multiple clamping grooves 31 are evenly distributed in the circumferential direction with the bolt 1 as the axis, and the clamping grooves 31 diverge outwards in the length direction with the bolt 1 as the axis; correspondingly, clamping buckles 22 are further arranged on the mounting nut 2 towards the front end face of the lock nut 3 in a protruding mode, preferably, the number of the clamping buckles 22 is two, and the two clamping buckles 22 are arranged on the two opposite sides of the mounting nut 2 in the width direction correspondingly; the lock nut 3 is screwed on the mounting nut 2, then the clamping buckles 22 are clamped in the clamping grooves 31, and thus the lock nut 3 is fixed; in the mounting process of the lock nut 3, the rear ends of the clamping buckles 22 can also serve as clamping parts for rotation of the lock nut 3.

Although the invention is specifically demonstrated and illustrated with the preferred embodiment, those skilled in the field should understand that various changes of the invention can be made in form and in detail without deviating from the spirit and scope defined by the claims and are all within the protection scope of the invention.

What is claimed is:

1. A lock bolt assembly, comprising a bolt provided with a first external thread and a mounting nut correspondingly screwed on the bolt and provided with a first internal thread;
wherein:
in the length direction of the bolt, at least one cantilever part is formed on the mounting nut in an extension mode, and the first internal thread extends onto the cantilever parts;
the lock bolt assembly further comprises a locking piece, and the locking piece is arranged on the mounting nut and abut against the cantilever parts, so that the areas, where the first internal thread is formed, of the cantilever parts bend and abut against the first external thread.

2. The lock bolt assembly according to claim 1, wherein defining the direction in which the mounting nut is screwed in the bolt as the forward direction, the cantilever parts are formed through backward extension.

3. The lock bolt assembly according to claim 1, wherein a second external thread is arranged on the outer wall of the mounting nut, the locking piece is a lock nut provided with a second internal thread, and the lock nut is screwed on the mounting nut through cooperation between the second internal thread and the second external thread.

4. The lock bolt assembly according to claim 3, wherein the number of the cantilever parts is two, the two cantilever parts are arranged on the two opposite sides of the bolt in the width direction respectively, and a deformation gap is formed between the two cantilever parts; the second external thread is arranged on the cantilever parts so that the lock nut can be arranged on the two cantilever parts in a sleeving mode, and the two cantilever parts are tightly pressed on the first external thread in an abutting mode.

5. The lock bolt assembly according to claim 3, wherein the cross section of each cantilever part is in an arc shape, so that the first internal thread and the second external thread are foil led on the inner side face and the outer side face of the cantilever part respectively.

6. The lock bolt assembly according to claim 3, wherein in the screwing direction of the lock nut, a plurality of clamping grooves are further formed in the front end face of the lock nut, and correspondingly, clamping buckles are further arranged on the mounting nut in a protruding mode towards the front end face of the lock nut; the lock nut is screwed on the mounting nut, and then the clamping buckles are clamped in the clamping grooves, so that the lock nut is fixed.

7. The lock bolt assembly according to claim 4, wherein in the screwing direction of the lock nut, a plurality of clamping grooves are further formed in the front end face of the lock nut, and correspondingly, clamping buckles are further arranged on the mounting nut in a protruding mode towards the front end face of the lock nut; the lock nut is screwed on the mounting nut, and then the clamping buckles are clamped in the clamping grooves, so that the lock nut is fixed.

8. The lock bolt assembly according to claim 5, wherein in the screwing direction of the lock nut, a plurality of clamping grooves are further formed in the front end face of the lock nut, and correspondingly, clamping buckles are further arranged on the mounting nut in a protruding mode towards the front end face of the lock nut; the lock nut is screwed on the mounting nut, and then the clamping buckles are clamped in the clamping grooves, so that the lock nut is fixed.

9. The lock bolt assembly according to claim 6, wherein the number of the clamping grooves is more than one, and the multiple clamping grooves are evenly distributed in the circumferential direction with the bolt as the axis; the number of the clamping buckles is two, and the two clamping buckles are mounted on the two opposite sides of the mounting nut in the width direction respectively.
